(19) United States
(12) Patent Application Publication
(10) Pub. No.: US 2004/0190042 A1
(43) Pub. Date: Sep. 30, 2004

(54) Providing enhanced utilization of printing devices in a cluster printing environment

(76) Inventors: Andrew Rodney Ferlitsch, Tigard, OR (US); Roy Kenneth Chrisop, Camas, WA (US)

Correspondence Address: Michael F. Krieger, Kirton & McConkie, 1800 Eagle Gate Tower, 60 East South Temple, Salt Lake City, UT, 84111, US

(21) Appl. No.: 10/400,745

(22) Filed: Mar. 27, 2003

(51) Int. Cl. G06F 3/12; G06F 15/00; G06F 15/16

(52) U.S. Cl. 358/1.15; 710/16; 710/17; 709/201; 710/19

(57) ABSTRACT

Systems and methods for redirecting all or part of a print job to one or more alternate printing devices in a local, remote or network printing environment, prior to or after the print job has been despooled to a printing device. Implementation takes place in association with one or more print jobs initiated for rendering in a printing environment. In at least one implementation, a method is provided for selectively allocating at least a portion of a print job from a lead printing device to an alternate printing device, the method comprising the steps for providing a printer cluster that includes a lead printing device and one or more alternate printing devices; identifying an availability of the alternate printing devices; identifying one or more capabilities of the alternate printing devices; and receiving print job distribution input at the lead printing device to determine distribution of a print job, wherein the print job is distributed at the lead printing device, and wherein the print job distribution is from the lead printing device or a client computer device.

### BACKGROUND OF THE INVENTION

1. Field of the Invention

The present invention relates to providing enhanced utilization of printing devices in a cluster-printing environment. More particularly, the present invention relates to systems and methods for redirecting all or part of a print job to one or more alternate printing devices in a local, remote or network printing environment prior to or after the print job has been despooled to a printing device.

2. Background and Related Art

Current techniques are currently available that relate to the redirection of print jobs. One technique utilizes a virtual printer driver to redirect a print job to an alternate printer, wherein the virtual printer driver is a wrapper around a plurality of printer drivers and/or printers. In this technique, the printing instructions (GDI) are passed from the source initiating the print job (application) to an intermediate driver (virtual printer driver), which performs a task and then passes the printing instructions to the targeted printer driver. An example of a task performed by the virtual printer driver is to obtain the status and capabilities of a plurality of printers. The virtual printer driver then matches the requirements of the print job to the status and capabilities of the printers and determines which printer best fits the print job. Using this technique, a user may typically print to a preferred printer (printer 1) using the virtual printer driver. And, if the user initiates a print job that requires a capability that printer 1 does not have (e.g., stapling), the virtual printer driver redirects the print job to an alternate printer (printer 2) that has the desired capability. While this technique redirects a print job, the versatility of the technique is limited.

Another technique used to redirect a print job includes client or server side clustering printing solutions. This technique provides pool printing and job splitting capabilities in a print processor, wherein a printer cluster is used to process print jobs and includes a lead printer and one or more alternate printers that are configured in a preference order. In this technique, a user may generally print to the lead printer (printer 1) using the lead printer mirrored driver. If the user desired to print a job that required a capability that the lead printer did not have (e.g., stapling), the print processor redirects the print job to an alternate printer (printer 2) that has the capability. While this technique redirects a print job and improves on other techniques, the versatility of this technique can also be limited.

Another technique used to redirect a print job includes a printer pooling capability that is built into an operating system. In this technique, a user associates an installed printer with multiple ports, wherein each port is associated with an alternate printing device. An installed printer with multiple ports is referred to as a “pool printer.” When the user sends a print job to a pool printer, the print subsystem determines if the lead printer in the pool is busy. If it is busy, the print subsystem redirects the print job to the next non-busy printer in the pool. While this technique redirects a print job, the versatility of the technique is also limited.

Another technique utilizes a tandem cable, which is a proprietary implementation that connects the marking engines of any two printers from the model line and provides the capability to send a raster image processing (RIP) image from one marking engine to the other marking engine. Using this feature, the printers can copy split a multiple copy print job and RIP the images once. While this technique may be preferred over other techniques that redirect a print job, the versatility of the technique can still be limited.

Another technique includes high speed, large capacity printers with multiple print engines, wherein a print job is broken up into sheets in these printers. When the sheets are RIP, the sheets are distributed to different print engines and printed in parallel. The distribution is performed such that the outputting of the sheets and the output path are synchronized and assembled in the correct page collation. This technique relates to a fault tolerant, multiple print engine printer, wherein failed portions of a print job are printed on an alternate print engine. In this technique, the printer has N print engines and one or more alternate print engines. If a print engine fails during a print job, the failed portion of the print job is sent to an alternate print engine and the printing path is resynchronized to maintain the correct page collation. This technology allows uninterrupted printing of the printer while maintenance is performed on the failed print engine. While this technique allows printers to document split a print job, RIP sheets once, and restart printing of a failed sheet to an alternate print engine, causing this technique to be preferred over other techniques, the versatility can still be limited.

Another technique provides a hardware based cluster solution that is external to the printer. The solution includes a server computing device and a proprietary controller that provides RIP and copy splitting capabilities. Print jobs in a PDL format (non-RIP), such as Postcript and PCT, are sent to the RIP server. The RIP server has sufficient resources to RIP the print job at a rate equal to or faster that the printing speed of the printer. The RIP server can also be configured to divide the number of copies in a multiple-copy print job and send the RIP output to multiple printers in parallel for copy splitting. While the use of this RIP server allows printers to copy split a print job, RIP sheets once, and print at engine speed, causing this technique to be preferred over others, the versatility of the technique can still be limited.

Another technique relates to splitting a print job across multiple printing devices after the print has been spooled to a printing device. In this technique, the print job includes print job commands for cluster printing. The cluster options (e.g., job splitting and pool printing) and alternate printing devices are obtained at the client computing device after the print job has been created (printer driver spools the print job to the spooler), but before being despooled to the printing device by a print processor or print assist. The cluster options are then added to the print job (modifying the print data), such as with proprietary PJL or other PDL commands. The modified print job is then sent to a printer that has firmware capabilities for interpreting the proprietary cluster commands and redirecting the print job to the alternate specified printing devices. While this technique allows printers to interpret cluster printing options, job split a print job, print pool a print job, render the print job once, single print stream from a client computing device, and restart a failed print job on an alternate printing device, causing this technique to be preferred over others, the versatility of the technique can still be limited.

Another technique relates to a network copier having a scanner and one or more printing devices in a local, remote or networking printing environment. In this technique, a print job is produced on the scanning device by scanning in a document and sent from the scanning device to one or more printing devices. The scanner output in the preferred embodiment is in a TIFF or other image format compatible with direct printing on the printing devices. The technology further provides a firmware-based system for specifying a printer cluster and cluster options through a user interface on the front panel. The output may be further modified by the addition of PJL or other PDL commands for specifying print options (e.g., duplex, stapling, paper selection). Using this technology, the scanners can generate a cluster print job, job split a print job, print pool a print job, and render the print job once or RIP once in direct printing. While this technology redirects a print job, it also can prove to limit versatility.

Thus, while techniques currently exist that are used to redirect print jobs, challenges still exist. Accordingly, it would be an improvement in the art to augment or even replace current techniques with other techniques.

### SUMMARY OF THE INVENTION

The present invention relates to providing enhanced utilization of printing devices in a cluster-printing environment. More particularly, the present invention relates to systems and methods for redirecting all or part of a print job to one or more alternate printing devices in a local, remote or network printing environment, prior to or after the print job has been despooled to a printing device.

Implementation of the present invention takes place in association with one or more print jobs initiated for rendering in a printing environment. In at least one implementation, a method is provided for selectively allocating at least a portion of a print job from a lead printing device to an alternate printing device, the method comprising the steps for providing a printer cluster that includes a lead printing device and one or more alternate printing devices; identifying an availability of the alternate printing devices; identifying one or more capabilities of the alternate printing devices; and receiving print job distribution input at the lead printing device to determine distribution of a print job, wherein the print job is distributed at the lead printing device, and wherein the print job distribution is from the lead printing device or a client computer device.

Further, implementation of the present invention embraces redirecting all or part of a print job to one or more alternate printing devices in a local, remote or network printing environment prior to or after the print job is despooled to a printing device, obtaining alternate choices of printing devices from the printer firmware that are capable of printing the print job, displaying the choices to the user and optionally notifying a user of when all or part of the print is redirected to an alternate printer device. Implementations of the present invention provide the versatility to (i) detect the status of a printing device (e.g., error, busy offline, etc.) and selectively redirect the print job to an alternate available printing device; (ii) detect that the print job has partially failed to print on the printing device, and selectively redirect all or part of the print job to an alternate printing device; (iii) detect a multiple copy print job and selectively redirect some of the copies to an alternate printing device (e.g., copy splitting); (iv) detect a multiple sheet print job and selectively redirect some of the sheets to an alternate printing device (e.g., document or copy splitting); (v) detect a mixed black & white and color print job and selectively redirect the black & white sheets to an alternate black & white printing device and/or redirect the color sheets to an alternate color printing device (e.g., color separation); (vi) detect the page per minute (ppm) capability of the printing device and an alternate printing device, and distribute a print job proportionally to the speed of the printing devices to compete the print job (e.g., load balancing); (vii) detect the sheet assembly capabilities (e.g., duplex, booklet, reverse order) of the printing device and an alternate printing device, and selectively distribute the print job according to sheet assembly requirements of the print job; (viii) detect the collation capabilities (e.g., copy collation, face-up) of the printing device and an alternate printing device, and selectively distribute the print job according to the collation requirements of the print job; (ix) detect a non-collating alternate printing device from a collating printing device, and emulate collation (e.g., brute force collation) on the alternate printing device; (x) detect the finishing capabilities (e.g., stapling, hole punch, saddle stitching, offset stacker, sorter, mail bin) of the printing device and an alternate printing device, and distribute the print job according to the finishing requirements of the print job; (xi) detect media capabilities and stock of the printing device and an alternate printing device, and selectively distribute the print job according to the media and stock requirements of the print job; (xii) RIP once on restarting failed portions of a print job on an alternate printing device; and (xiii) prevent alternate printing devices from needing to be installed on a client or server computing device.

As will be provided herein, implementation of the present invention further relates to systems and methods for providing increased utilization of printing devices with cluster printing capabilities without requiring additional client or server side software to identify alternate printing devices, to configure the alternate printing devices and to discover the status and capabilities of the alternate printing devices. Further, at least some implementations of the present invention obtain alternate choices of printing devices from the printer firmware capable of printing the print job and display the choices to the user for selection.

At least some implementations of the present invention further embrace a method to send part or all of a print job from one printing device to one or more compatible printing devices, such as in cluster printing (e.g., pool printing and job splitting), through the use of printer driver, printer firmware, and a front panel user interface. Furthermore, additional implementations of the present invention embrace a method to send all or part of a print job from one printing device to one or more compatible printing devices, such as in cluster printing (e.g., pool printing and job splitting), through the use of printer firmware, network interface card (NIC), and a front panel user interface. Those skilled in the art will appreciate that the methods and processes of the present invention can be used in association with a variety of different applications and in a variety of different printing environments to enable print jobs to be dynamically rendered in a printing environment.

These and other features and advantages of the present invention will be set forth or will become more fully apparent in the description that follows and in the appended claims

The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative printing environment;

FIG. 3 is a flow chart that provides representative processing relating to a print job;

FIG. 4 illustrates a representative printer pooling menu and configuration;

FIG. 5 illustrates another representative printer pooling menu and configuration;

FIG. 6 illustrates an alternate printer configuration;

FIG. 7 illustrates representative processing relating to selectively redirecting one or more print jobs;

FIG. 8 illustrates alternate processing relating to selectively redirecting one or more print jobs;

FIG. 9 illustrates representative print job settings;

FIG. 10 illustrates representative cluster settings;

FIG. 11 illustrates representative embodiment of querying the printer status and/or capabilities;

FIG. 12 illustrates another representative embodiment of querying the printer status and/or capabilities;

FIG. 13 illustrates another representative embodiment of querying the printer status and/or capabilities;

FIG. 14 illustrates another representative embodiment of querying the printer status and/or capabilities;

FIG. 15 illustrates a representative embodiment for providing selectable alternatives; and

FIG. 16 illustrates a representative embodiment for redirecting one or more print jobs.

### DETAILED DESCRIPTION OF THE INVENTION

The present invention relates to providing enhanced utilization of printing devices in a cluster-printing environment. More particularly, the present invention relates to systems and methods for redirecting all or part of a print job to one or more alternate printing devices in a local, remote or network printing environment, prior to or after the print job has been despooled to a printing device.

Embodiment of the present invention takes place in association with one or more print jobs that are initiated in a printing environment for rendering the print jobs. In at least one embodiment, a method is provided for selectively allocating at least a portion of a print job from a lead printing device to an alternate printing device, wherein the method comprises providing a printer cluster that includes a lead printing device and one or more alternate printing devices; identifying an availability of the alternate printing devices; identifying one or more capabilities of the alternate printing devices; and receiving print job distribution input at the lead printing device to determine distribution of a print job, wherein the print job is distributed at the lead printing device, and wherein the print job distribution is from one of (i) the lead printing device; and (ii) a client computer device.

At least some embodiments of the present invention embrace redirecting all or part of a print job to one or more alternate printing devices in a local, remote or network printing environment prior to or after the print job is despooled to a printing device, obtaining alternate choices of printing devices from the printer firmware capable of printing the print job, displaying the choices to the user and optionally notifying a user of when all or part of the print is redirected to an alternate printer device. Some of the embodiments of the present invention (i) detect the status of the printing device (e.g., error, busy offline, etc.) and selectively redirect the print job to an alternate available printing device; (ii) detect that the print job has partially failed to print on the printing device and selectively redirect all or part of the print job to an alternate printing device; (iii) detect a multiple copy print job and selectively redirect some of the copies to an alternate printing device (e.g., copy splitting); (iv) detect a multiple sheet print job and selectively redirect some of the sheets to an alternate printing device (e.g., document or copy splitting); (v) detect a mixed black & white and color print job and selectively redirect the black & white sheets to a black & white printing device and/or the color sheets to an alternate color printing device (e.g., color separation); (vi) detect the page per minute (ppm) capability of one or more printing devices and selectively distribute the print job proportionally to the speed of the printing devices to compete the print job (e.g., load balancing); (vii) detect the sheet assembly capabilities (e.g., duplex, booklet, reverse order) of the printing device and alternate printing devices and selectively distribute the print job according to sheet assembly requirements of the print job; (viii) detect the collation capabilities (e.g., copy collation, face-up) of the printing device and alternate printing devices and selectively distribute the print job according to the collation requirements of the print job; (ix) detect a non-collating alternate printing device from a collating printing device and emulate collation (e.g., brute force collation) on the alternate printing device; (x) detect the finishing capabilities (e.g., stapling, hole punch, saddle stitching, offset stacker, sorter, mail bin) of the printing device and alternate printing devices and selectively distribute the print job according to the finishing requirements of the print job; (xi) detect media capabilities and stock of the printing device and alternate printing devices and selectively distribute the print job according to the media and stock requirements of the print job; (xii) RIP once on restarting failed portions of a print job on an alternate printing device; and (xiii) prevent alternate printing devices from needing to be installed on a client or server computing device.

Embodiments of the present invention embrace other or additional aspects, including providing increased utilization of printing devices with cluster printing capabilities without requiring additional client or server side software to identify alternate printing devices, configuring the alternate printing devices, discovering the status and capabilities of the alternate printing devices, obtaining alternate choices of printing devices from the printer firmware capable of printing the print job and displaying the choices to the user, and the like.

The following disclosure of embodiments of the present invention is grouped into three subheadings, namely “Exemplary Operating Environment,” “Firmware Based Cluster Printing” and “Driver Based and Firmware Assist Cluster Printing.” The utilization of the subheadings is for convenience of the reader only and is not to be construed as limiting in any sense.

### Exemplary Operating Environment

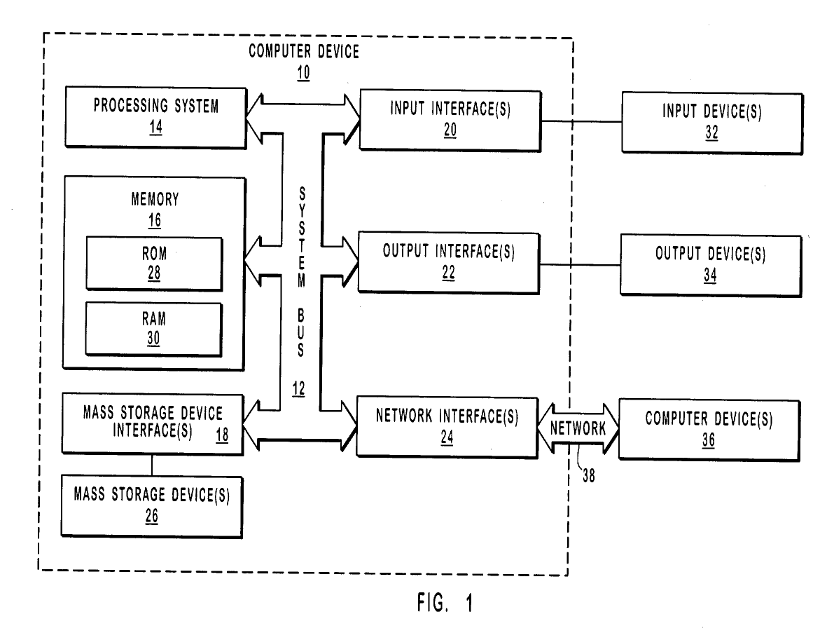

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

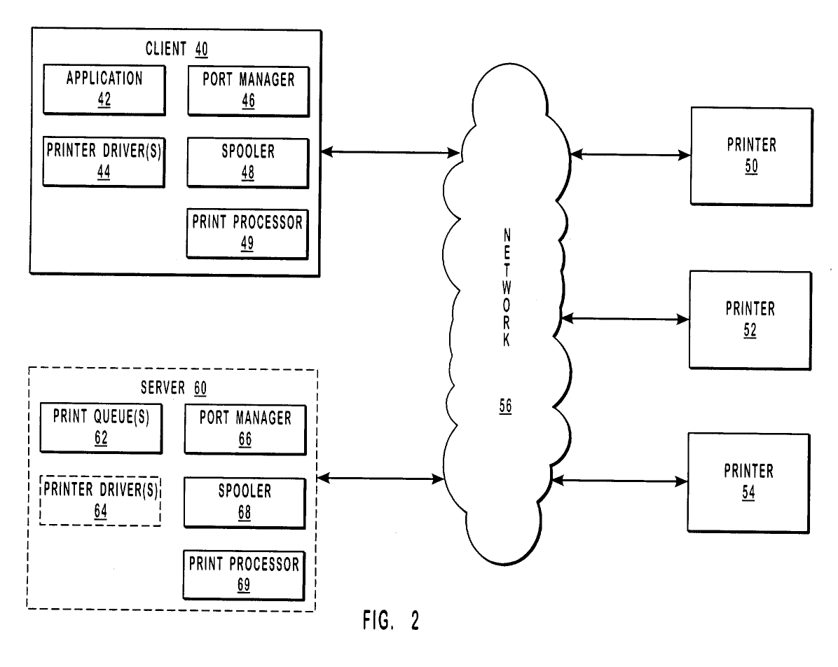

While those skilled in the art will appreciate that embodiments of the present invention may be practiced in a variety of different environments with many types of computer system configurations, FIG. 2 represents a representative networked system configuration that may be used in association with the present invention. While FIG. 2 illustrates an embodiment that includes a client, three printer device, and optionally a print server connected to a network, alternative embodiments include more than one client, two printers, more than three printers, no server, and/or more than one server connected to a network. Other embodiments of the present invention include local, networked, or peer-peer printing environments. Moreover, embodiments in accordance with the present invention also include wireless networked environments, or where the network is a wide area network, such as the Internet.

Some embodiments of the present invention include two or more compatible printers (e.g., identical PDL interpreters and optionally required finishing/assembly capabilities) connected in a local, remote or network print environment, a computer device capable of spooling a print job, and optionally a printer driver and print processor compatible with the printing devices (e.g., driver based printing vs. direct printing), such as in the Microsoft® Windows® 98/Me, NT/2k and XP operating systems.

With reference now to FIG. 2, a representative printing environment is provided. FIG. 2, provides a computer device, illustrated as client 40, which is connected to a plurality of printing devices (printers 50-54) across network 56. In the illustrated embodiment, printer 50 is a lead printing device and printers 52 and 54 are alternate printing devices. Each of the printing devices includes printing capabilities. In one embodiment, the capabilities of two or more of the printer devices are heterogeneous (e.g., at least one of the capabilities of one of the printers are different from the capabilities of one or more of the other printers). In another embodiment, the capabilities of the printer devices are homogeneous.

While printers 50-54are connected to network 56, embodiments of the present invention embrace the use of printing devices that are locally connected to a computer device, remotely connected to a computer device, configured in a peer-to-peer printing environment, or configured in a wireless network environment. Further, the printing devices may be one or more multi-function printers MFPs, or facsimile devices.

In the illustrated embodiment, client 40 includes a software application 42, one or more print drivers 44, a port manager 46, a spooler 48, and a print processor 49. A printer server 60 is optionally included having, for example, one or more print queues 62, one or more printer drivers 64, a port manager 66, a spooler 68, and a print processor 69.

In accordance with the illustrated embodiment and other embodiments of the present invention, enhanced utilization of printing devices in a cluster-printing environment is provided. At least some embodiments include a computer based printing system having one or more print drivers, a spooler, print processor, two or more printing devices and optionally one or more print servers, wherein the system results in increasing utilization (e.g., high availability and high performance) of printing devices with cluster printing capabilities (e.g., pool printing and job splitting) in the printer driver and printer firmware. At least some embodiments of the present invention have the advantage of not requiring additional or any client or server side software to identify, configure alternate printing devices and discover the status/capabilities of the alternate printing devices by having the cluster capabilities configured in the printer firmware and optionally having the redistribution of a print job performed in the printer firmware. Accordingly, embodiments of the present invention embrace systems and methods for redirecting all or part of a print job to one or more alternate printing devices in a local, remote or network printing environment prior to or after the print job has been despooled to a printing device, as will be further explained below.

### Firmware Based Cluster Printing

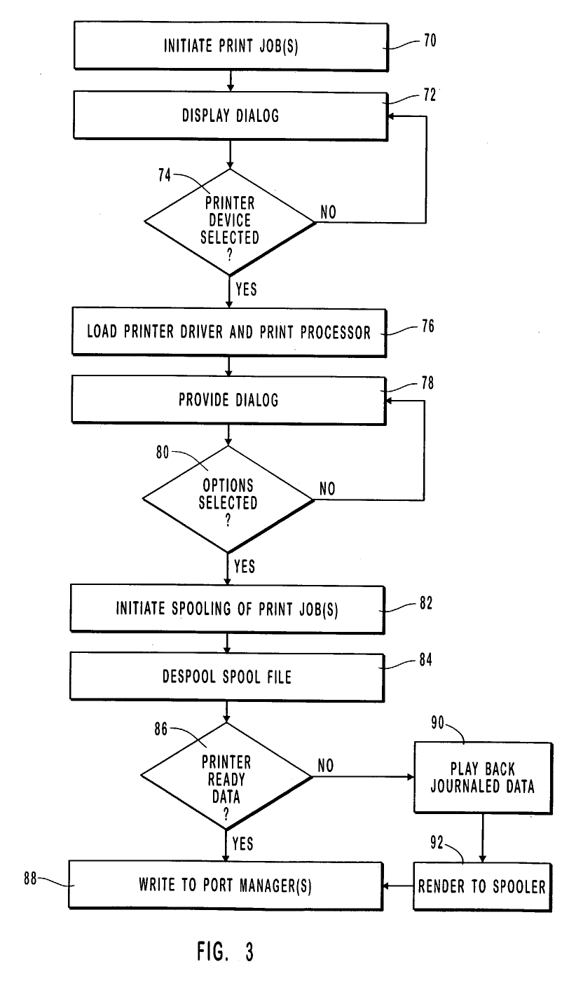

With reference now to FIG. 3, a flow chart is illustrated that provides representative processing relating to a print job. In FIG. 3, the user initiates a print job at step 70. The print job(s) include one or more documents, each including one or more pages, and collectively having of one or more copies thereof. The print job may be preprocessed into printer ready data, such as by an application rendering its output into a page description language (PDL), such as PCL, Postscript, PDF, TIFF, or another description language. The print job may alternatively be journaled, wherein the rendering instructions are recorded and the playback of the rendering instructions is deferred, such as in an enhanced meta file (EMF) and in a printer meta file (PMF).

Upon initiation of the print job at step 70, the user selects a command or sequence of commands and/or stimulus to the computing device, which indicates the user's intention to spool a print job. The computing device responds to the user by presenting the user a dialog (e.g., a Printer UT, command line query, front panel display etc.) at step 72, in which the user may select one or more options relating to the spooling of the print job. One of the options is the selection of a printing device (e.g., printer, plotter, MFP, CD burner, fax machine, etc.) to despool the print job thereto. At decision block 74, a determination is made as to whether or not a printer device has been selected. If it is determined that a printer device has not been selected, execution returns back to step 72.

Once a printer device has been selected, the computing device responds by loading the printer driver and print processor associated with the printing device at step 76, and the printer driver responds automatically or by user initiation by presenting the user a dialog at step 78 that allows the user to select one or more options relating to the printing device's capabilities (e.g. print quality, paper size, orientation, tray selection, manual feed, duplexing, collation, stapling, hole punching, watermarks, etc.).

In direct printing systems, the user spools print jobs without preprocessing (e.g., rendering or journaling) the document and/or image data through a printer driver. In these systems, the print data remains in the native document and/or image format, and the printing device is assumed to have the capability of interpreting/processing the respective formats.

At decision block 80, a determination is made as to whether or not the user has completed selecting the options. Once the user has completed selecting options specific to both the print job and the printing device(s), the computing device initiates the spooling of the print job at step 82, which includes the printer driver constructing print job specific information (e.g. DEVMODE in Microsoft® operating systems), compiling rendering instructions, and providing the print data in a printer ready journaled format.

All or part of the print job may be already rendered into printer ready data, and thus a step of compiling rendering instructions may be skipped. The output from the print driver (e.g., spooled print job) is generally referred to as a spool file and the content is generally referred to as spool data, which may be on disk, in memory, in cache, or all other forms of storage compatible with the computing device. In direct printing, the print data is not preprocessed by a printer driver. Instead, the print job includes print job options and the document/image data is in a native format, and is spooled directly to the Spooler.

Once the spool file is completed, the spooler immediately or on a delayed basis despools the spool file to the associated print processor for the selected printing device(s) at step 84. At decision block 86, the print processor reads the spool file and determines if the content is preprocessed printer ready data (e.g., RAW mode in the Microsoft® operating systems), or journaled (e.g., EMF mode in the Microsoft® operating system). If the print data is printer ready data, the print processor writes the print data directly to the port manager(s) of the corresponding printing device(s) at step 88. Alternatively, if it is determined at decision block 86 that the print data is not in a printer ready format, the print processor plays back the journaled data to the printer driver(s) associated with the corresponding printing device(s) at step 90. The printer driver(s) then render the journaled data and spool the printer ready data to the Spooler at step 92. Execution then proceeds to step 88, where the spooler then writes the printer ready data directly to the port manager(s) of the corresponding printing device(s).

In the Microsoft® Windows® NT/2K and XP operating systems, the step of playing back the journaled data to the printer driver may be deferred to a printer server. Accordingly, a spooler writes the journaled data directly to the port manager(s) of the printer server(s) associated with the corresponding printing devices and then the journaled data is spooled to a print queue on the printer server. The server spooler immediately or on a delayed basis despools the spool file to the associated server print for the selected printing device(s). The server print processor plays back the journaled data to the server printer driver(s) associated with the corresponding printing device(s). The server printer driver(s) then render the journaled data and spool the printer ready data to the server Spooler. The server Spooler then writes the printer ready data directly to the server port manager(s) of the corresponding printing device(s).

In at least some embodiments of the present invention, the targeted or lead printing device has clustering capabilities built into the printing device, wherein the clustering capabilities are configurable. In one embodiment, the clustering settings are input on the front panel display of the device. In another embodiment, the cluster settings are configured by downloading from external source (e.g., web site, printer server) or by installation via media (e.g., CD/floppy disk).

In some embodiments, the cluster configuration includes (i) alternate printing devices (e.g., network/IP addresses, a network queue, etc.); (ii) pool printing (e.g., busy, error state/offline, capabilities matching, job failure restarting, etc.); (iii) capabilities discovery, including sheet assembly (e.g., duplex, booklet, n-up, reverse order, 1^{st} page different), finishing (e.g., stapling, saddle stitch, hole punch, offset stacking, sorting), media/stock (e.g., paper size, paper type, amount of paper, output capacity), rendering (e.g., dpi, color matching, watermark, forms, PDLs), and/or collation (e.g., copy collation, face up, mechanical collation, disk/ram), speed (e.g., pages per minute—“PPM”).

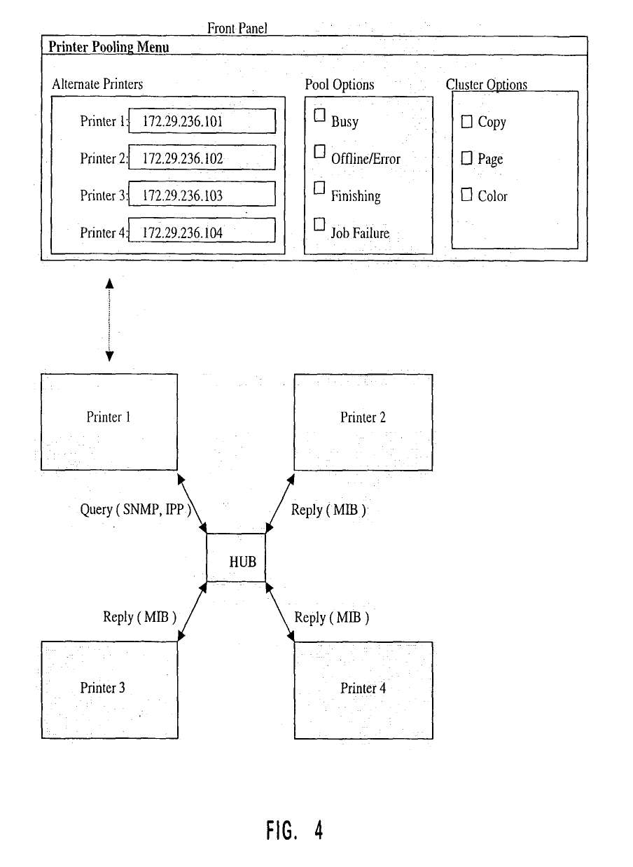

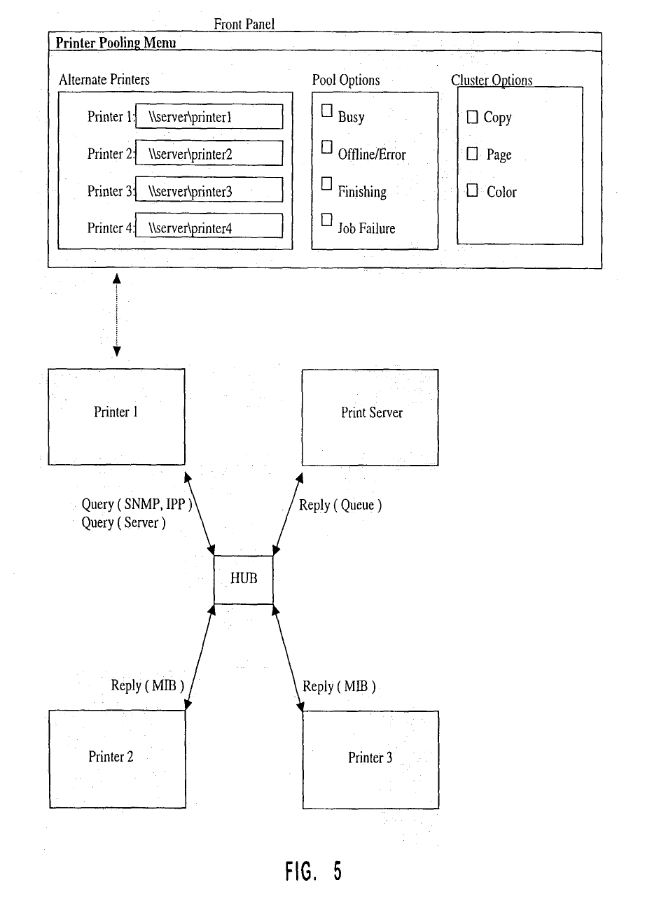

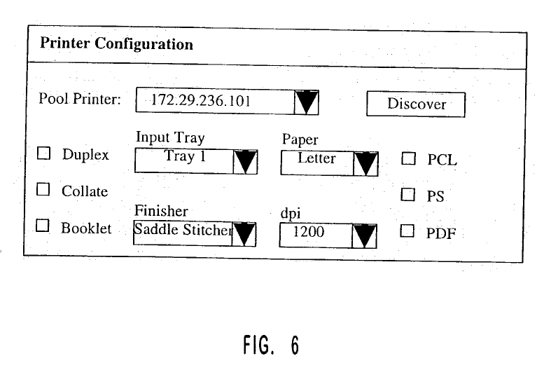

In some embodiments, the capabilities of the printing device and alternate devices are discovered by (i) auto discovery (e.g., a SNMP query), (ii) a predefined printer database, (iii) a configuration file, wherein the source is external (e.g., server), some media (e.g., CD), a device (e.g., printer), and/or by manual input. By way of example, a user may create a printer group of three printers that are located next to each other for rollover when a printer is unavailable (e.g., busy, offline, error, etc.) or when the capabilities of the printer do not match. If the printing devices are identical except that two of the printers have a stapling/sorter finisher and the third printer does not, the cluster is configured (i) by entering the IP Address of the other two printing devices, (ii) by enabling the printer pooling for busy, offline/error and capabilities matching, and (ii) by auto discovery of the capabilities of the other two printing devices. FIGS. 4-6 are examples of such embodiments, wherein FIG. 4 illustrates a representative printer pooling menu and configuration, FIG. 5 illustrates another representative printer pooling menu and configuration, and FIG. 6 illustrates an alternate printer configuration.

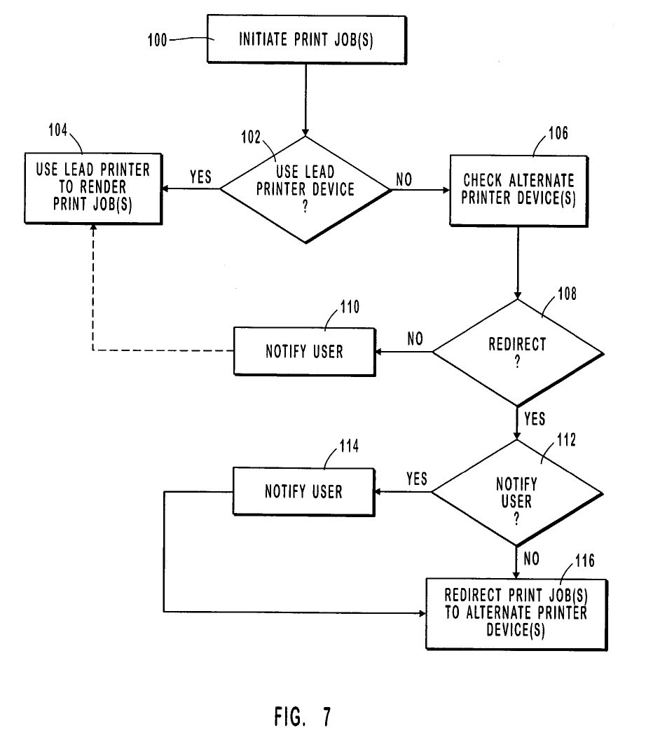

With reference now to FIG. 7, representative processing is provided relating to selectively redirecting one or more print jobs. In FIG. 7, execution begins at step 100, where one or more print jobs are initiated. A determination is then made at decision block 102 as to whether or not to use the lead printer for all of the processing of the one or more print jobs. If it is determined to use the lead printer, execution proceeds to step 104 to render all of the print jobs. Alternatively, if it is determined that one or more alternate printing devices may be used, execution proceeds to step 106, where the alternate printing devices are checked. A determination is then made at decision block 108 as to whether or not to redirect all or part of the print job(s). If redirection is not to occur, execution proceeds to step 110, where the user may be notified that, for example, the lead printing device is unable to be used and that no alternate printing devices are available for use. Optionally, it may be determined that the alternate printers are not able or available to render the print job and so the lead printer is used to render the print job at step 104.

Alternatively, if it is determined that all or part of the print job(s) is to be redirected, a determination is made at decision block 112 as to whether or not to notify the user of the redirection. If the user is to be notified, this is performed at step 114 and then the redirection occurs at step 116. Alternatively, if the user is not notified, execution proceeds directly to step 116.

The following provide specific examples of the processing represented in FIG. 7. When a print job is initiated at step 100 to a device configured for clustering, the printing device performs the following types of actions depending on the status and capabilities of the devices, the requirements of the print job and the cluster settings.

A first embodiment relates to when the lead printer device is busy. When a print job has been sent to a printing device that is currently printing another print job (e.g., busy), the lead printing device checks the status of the alternate printing devices (step 106). The lead printing device may then redirect the print job (step 116) to an alternate printing device under various conditions, such as to (i) an alternate printing device that is in an idle state and warmed up, (ii) an alternate printing device that is in an idle state and non-warmed up (e.g., power save mode), or (iii) an alternate printing device that is in a busy state having the smallest load.

In another embodiment relates to the lead printing device is in an error or offline state. When a print job has been sent to a lead printing device that is in an error (e.g., paper jam) or offline state (e.g., set to offline on front panel), the lead printing device checks the status of the alternate printing devices (step 106). The lead printing device may then redirect the print job to an alternate printing device (step 116) under various conditions, such as to (i) an alternate printing device that is in a non-error/offline state, or (ii) an alternate printing device that is in a warning state (e.g., low toner),

Another embodiment relates to capabilities matching. When a print job has been sent to a lead printing device that does not have one or more capabilities required for rendering the print job (e.g., duplex, stapling), the lead printing device checks the capabilities of the alternate printing devices (step 106). The lead printing device may then redirect the print job (step 116) to an alternate printing device under various conditions, such as to (i) an alternate printing device that has capabilities required for the print job and wherein the entire print job is restarted, or (ii) an alternate printing device that has capabilities required for print job and wherein the unprinted portion of the print job is restarted.

Another embodiment relates to job failure. When a print job has been sent to a lead printing device that fails to complete the printing of the print job, such as when a paper jam occurs during the printing of the job, the lead printing device checks the status of the alternate devices (step 106). The lead printing device may then redirect all or part of the print job to an alternate printing device under various conditions, such as to an alternate printing device that is in a non-error/offline state.

Another embodiment relates to copy splitting. When a multiple copy print job has been sent to a lead printing device, the lead printing device checks the capabilities of the alternate devices (step 106). The printing device may then split the number of copies printed on each printing device by sending a copy of the print job (step 116) to each alternate printing device (step 116) with the copy count command adjusted accordingly. This may be performed under various conditions, such as (i) in equal distribution—e.g., the same number of copies, (ii) in a load balanced distribution—e.g., ppm speed.

Another embodiment relates to document splitting. When a multiple page print job has been sent, the lead printing device checks the capabilities of the alternate devices (step 106). The lead printing device may then split the sheets printed on each printing device (step 116) by sending a modified version of the print job, which includes only the corresponding sheets for rendering, to each alternate printing device. This may be performed under such representative conditions as (i) equal distribution—e.g., the same number of copies, (ii) load balanced distribution—e.g., ppm speed, or (iii) another condition.

Another embodiment relates to color separation. When a mixed black & white and color print job is sent, the lead printing device checks the capabilities of the alternate devices (step 106). The printing device may then separate the color and black & white sheets printed on each printing device by sending a modified version of the print job (step 116) that includes only the corresponding sheets for rendering at each alternate printing device. Examples of such conditions include (i) sending color sheets to a color printing device or (ii) sending black & white sheets to a black & white printing device.

At least some embodiments of the present invention also embrace providing the user with instructions for reassembly of the print job. Examples include (i) reassembly by user notification (e.g., send instructions back as message to client computing device), (ii) reassembly by instructions printed with the print job, or (iii) another manner.

While the above examples illustrate representative actions taken for a specific cluster setting, the settings may also be combined for more complex actions, such as busy and capabilities matching in pool printing.

In one embodiment, when a print job is sent to a network or remote printing device, the following steps typically occur: (i) the client establishes a connection with the printing device, using the appropriate protocol and port; (ii) the client sends a message to the printing device to indicate a request to despool a print job; (iii) the printing device acknowledges the request; (iv) the client sends a print job to the printing device, using the appropriate protocol; and (v) the client sends a message to the printing device that the entire job has been despooled. In at least one embodiment, the connection utilizes a network interface card (NIC) on the printing device and the communication is performed via an industry standard protocol, such as LPR.

In at least some embodiments, when a print job is redirected from the printing device to an alternate printing device, the same method of connection, transmission and protocols are followed. Accordingly, there is no requirement for a proprietary mechanism to move the print job from one printer to another. Thus, in some embodiments, when a lead printing device redirects a print job to an alternate printing device, the following occurs: (i) the lead printing device establishes a connection with an alternate printing device, using an appropriate protocol and port; (ii) the lead printing device sends a message to the alternate printing device to indicate a request to despool a print job; (iii) the alternate printing device acknowledges the request; (iv) the lead printing device sends all or part of the print job to the alternate printing device, using an appropriate protocol; (v) the lead printing device sends a message to the alternate printing device that the entire job has been despooled; and (vi) the lead printing device deletes the redirected portion of the print job.

Accordingly, in some embodiments of the present invention, only the lead/target printer includes a special firmware/front panel display—the alternate printers do not require the special firmware/front panel.

As illustrated in FIG. 7, when a cluster configured printing device redirects all or part of a print job, the user may be notified of the redirected. To notify the user, the printing device obtains information of the source of the print job. Since a print job may travel through intermediate sources, such as a printer server, the method must be reliable. One example of such a method in accordance with the present invention relates to embedding the source of the print job into the print job. This embedding may include (i) a network address of the client computing device, and/or (ii) an user identification of sender.

In some embodiments, the printing device then uses the information to send a notification back to the user, wherein (i) the network address is used to send a message back to a printer monitoring program on the computing device (Sharp® Corporation's Status Monitor is an example of such a printer monitoring program.); (ii) the network address may is used to send an instant message back to the computing device (AOL and MSN are examples of industry standards for instant messaging.); or (iii) the user identification may be used to send an electronic mail message (i.e., email) back to the user.

In an alternate embodiment, the printing device requires user confirmation before redirecting all or part of a print job to an alternate printing device. This may include, for example, (i) establishing bi-directional communication with a printer monitoring program on the computing device and requesting confirmation; and (ii) requiring confirmation on the front panel of the printing device and notifying the user appropriately.

### Driver Based and Firmware Assist Cluster Printing

With reference back to FIG. 3, a user initiates a print job at step 70 that includes one or more documents, each document having of one or more pages and collectively having one or more copies thereof. The print job may be preprocessed into printer ready data, such as an application rendering its output into a page description language (PDL), such as PCL, Postscript, PDF, TIFF, or another language. As provided herein, the print job may also be journaled, where the rendering instructions are recorded, and the playback of the rendering instructions is deferred, such as with an enhanced meta file (EMF) or a printer meta file (PMF).

Upon initiation of the print job, the user selects a command or sequence of commands and/or stimulus to the computing device to indicate that the user intends to spool a print job. The computing device responds to the user at step 72 by presenting the user a dialog (e.g., a Printer UI, command line query, front panel display), in which the user can select options relating to the spooling of the print job. One of the options is the selection of the printer device (e.g., printer, plotter, MFP, CD burner, fax machine, but not limited to) to despool the print job thereto. Accordingly, a determination is made at decision block 74 as to whether or not the printer device has been selected. Once the printer device is selected, the computer device responds by loading the printer driver and print processor associated with the printer device at step 76. The printer driver responds (automatically or by user initiation) to the user by presenting the user a dialog at step 78 from which the user can select options relating to the printer device's capabilities (e.g., a print quality, paper size, orientation, tray selection, manual feed, duplexing, collation, stapling, hole punching, watermarks, etc.).

In direct printing systems, the user spools print jobs without preprocessing (e.g., rendering or journaling) the document and/or image data through a printer driver. In these systems, the print data remains in the native document and/or image format, and the printing device is assumed to have the capability of interpreting/processing the respective formats.

In at least on embodiment, the dialog presented to the user is for selecting options specific to the printing device's capabilities, including a dialog on cluster printing. In an alternate embodiment, the dialog for selecting cluster specific options may be presented by an application, background process, print processor, spooler, print assistant (e.g., any component not otherwise part of the print subsystem that is inserted into the printing process) or be pre-specified.

Within the dialog, the user can optionally select to split the print job (e.g., document splitting) and/or copies of the print job (e.g., copy splitting) across multiple printing devices, perform color separation, or route the print job to the best fit printer (e.g., pool printing). The dialog may include a display of all the selectable printing devices in the cluster, the printer's status, and printer's capabilities, such as PPM (pages per minute), duplexing, collation, stapling, paper selection, input/output trays, where the user can select one or more for despooling the print job thereto

In embodiments of the present invention, the list of the alternate printing devices, their capabilities and status are obtained from the lead or target printing device, as is discussed herein.

Once the user has completed selecting options specific to both the print job and the printer device(s), the computer device initiates the spooling of the print job. The steps include, for example, having a printer driver (i) construct print job specific information (e.g. DEVMODE in Microsoft® operating systems), (ii) compile rendering instructions, and (iii) render preprocessed data into printer ready data or recording data for deferred playback (e.g., journaling). Some or the entire print job may already be rendered into printer ready data. Accordingly, a step for compiling rendering instructions may then be skipped partly or entirely. The output from the print driver (spooled print job) is generally referred to as a spool file, with the content generally referred to as spool data, and may be on disk, in memory, in cache, or another forms of storage compatible with the computing device.

In direct printing, the print data is not preprocessed by a printer driver. Instead, the print job includes print job options and the document/image data in native format, and is spooled directly to the Spooler.

Accordingly, at step 82 the spooling of the print job(s) is initiated. Once the spool file is completed, the spooler despools (immediately or delayed) the spool file to the associated print processor for the selected printing device(s) at step 84. The print processor reads the spool file and determines if the content is preprocessed printer ready data (e.g., RAW mode in the Microsoft® operating systems) or journaled (e.g., EMF mode in the Microsoft® operating system). A determination is made at decision block 86 as to whether or not the print data is printer ready. If the print data is printer ready data, the print processor writes the print data directly to the port manager(s) of the corresponding printing device(s) at step 88. Alternatively, the print processor plays back the journaled data to the printer driver(s) associated with the corresponding printing device(s) at step 90. The printer driver(s) then render the journaled data and spool the printer ready data to the spooler at step 92. The spooler then writes the printer ready data directly to the port manager(s) of the corresponding printing device(s) at step 88.

In the Microsoft® Windows® NT/2K and XP operating systems, a step of playing back the journaled data to the printer driver may be deferred to a printer server. In this case, the spooler writes the journaled data directly to the port manager(s) of the printer server(s) associated with the corresponding printing devices. The journaled data is then spooled to a print queue on the printer server. The server spooler (e.g., on the printer server) despools (immediately or delayed) the spool file to the associated server print for the selected printing device(s). The server print processor plays back the journaled data to the server printer driver(s) associated with the corresponding printing device(s). The server printer driver(s) then render the journaled data and spool the printer ready data to the server spooler. The server spooler then writes the printer ready data directly to the server port manager(s) of the corresponding printing device(s).

In at least some embodiments of the present invention, the lead or target printing device has printer grouping capabilities built into the printing device, wherein the grouping capabilities are configurable. In at least one embodiment, the printer group settings are input on the front panel display of the device. In alternate embodiments, the printer group settings are configured by, for example, being (i) downloaded from an external source (e.g., web site, printer server) or (ii) installed via media (e.g., CD/Floppy Disk).

In some embodiments, the cluster configuration includes alternate printing devices, such as network/IP addresses, a network, etc. The cluster configuration also includes capabilities discovery, such as for the sheet assembly (e.g., duplex, booklet, n-up, reverse order, ^{st} page different), finishing (e.g., stapling, saddle stitch, hole punch, offset stacking, sorting), media/stock (e.g., paper size, paper type, amount of paper, output capacity), rendering (e.g., dpi, color matching, watermark, forms, PDLs), collation (e.g., copy collation, face up, mechanical collation, disk/ram), and speed (e.g., PPM).

In accordance with embodiments of the present invention, capabilities of the printing devices may be discovered, for example, by auto discover (e.g., an SNMP query), by use of a predefined printer database, by use of a configuration file, wherein the source may be external (e.g., server), media (e.g., CD), device (e.g., printer), or another, or by manual input.

By way of example, a user may create a printer group of three printers that are located next to each other. To configure the printer group, for each printing device, the user may (i) enter the IP address of the other two printing devices or (ii) select to automatically discover the capabilities of the other two printing devices. Representative examples are provided as FIGS. 4-6.

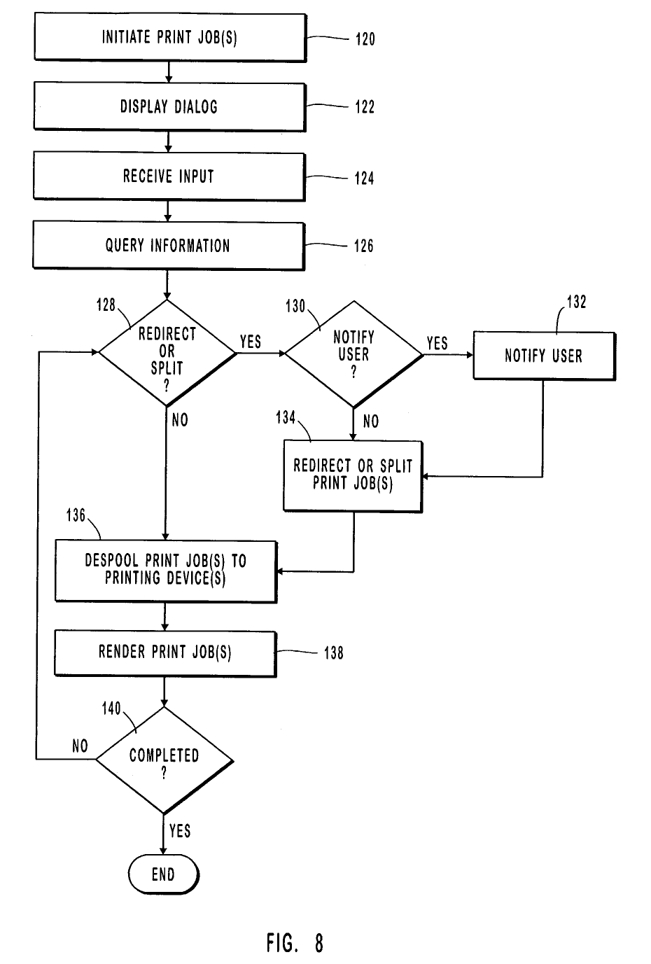

With reference now to FIG. 8, representative processing is provided relating to selectively redirecting one or more print jobs. In FIG. 8, one or more print jobs are initated at step 120. A dialog is displayed at step 122 and input is received at step 124. Information is queried at step 126. A determination is then made as step 128 as to whether or not to redirect or split a print job. If all or part of a print job is to be redirected, execution proceeds to step 130 for a determination as to whether or not to notify the user. If the user is to be notified, the user is notified at step 132 and then execution proceeds to step 134. Alternatively, if the user is not to be notified, execution proceeds directly to step 134, where all or part of the print job is redirected.

At step 136, the print job(s) are despooled to the printing device(s). At step 138 the print job(s) are rendered at the printing device(s). A determination is then made at step 140 as to whether or not the print jobs were completed. If the print jobs were not completed, for example due to a paper jam, execution returns back to decision block 128 to determine whether to redirect the print jobs so that they may be completely rendered.

When a print job is initiated to a device configured for printer grouping, the printer driver typically performs the following types of actions, depending on the status and capabilities of the devices, the requirements of the print job, and the cluster settings.

A first action relates to print settings. The process starts when a print job is initiated by the invocation of the cluster printer driver. The cluster printer driver displays a dialog to the user and the user inputs the print job settings, such as sheet assembly (e.g., duplex, booklet, N-up, orientation, reverse order, page range, banner page, etc.), collation (e.g., copies, face-up printing, etc.), paper selection (e.g., paper size, paper type, first page different, etc.), output trays (e.g., mail trays, large capacity trays, offset trays, stackers, sorters, etc.), rendering (e.g., resolution or dpi, margin, etc.), and finishing (e.g., stapling, hole punch, saddle stitching, etc.).

In an alternate embodiment, the dialog for selecting print options may be presented by an application, background process, print processor, spooler, print assistant (e.g., any component not otherwise part of the print subsystem that is inserted into the printing process) or be pre-specified.

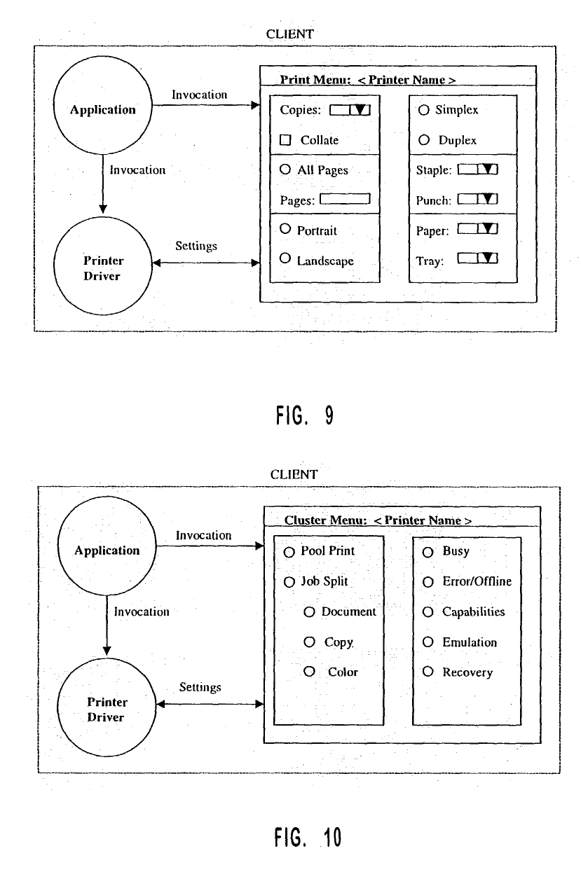

Direct Printing is an example of an alternate embodiment, where the print settings are specified in an application (e.g., print submit) and the application sends the documents unprocessed (i.e., bypass printer driver) directly to the spooler. FIG. 9 provides a representative example thereof.

In one embodiment, the cluster printer includes a dialog for cluster settings. The dialog includes, for example, pool printing (e.g., busy, error/offline, capabilities matching, capabilities emulation, job recovery, etc.) and job splitting (e.g., copy splitting, document splitting, color separation, load balancing, etc.).

In an alternate embodiment, the dialog for selecting cluster options may be presented by an application, background process, print processor, spooler, print assistant (i.e., any component not otherwise part of the print subsystem that is inserted into the printing process) or be pre-specified. FIG. 10 provides a representative example thereof.

Prior to rendering the print data and despoiling the print job to the printing device, the lead printer driver queries the printing device for the printer group information. This information includes, for example, identification information (e.g., printer name, model name, network address, queue, locality, etc.), capabilities information (e.g, sheet assembly, collation, paper selection, trays, rendering, finishing, etc.), and status information, such as ready (e.g., power save, warming up, idle), busy (e.g., number of jobs, time to availability), offline/non-communicating, etc.), warning (e.g., low toner, low paper, service required, etc.), and error (e.g., paper jam, door open, out of paper, no toner, etc.)

The lead printer driver may query the alternate printing devices through a variety of manners, including industry standard methods and proprietary methods. If the printing device is connected locally (e.g., parallel port), the printing device may be queried with bi-directional communication (e.g., BiDi). If the printing device is connected remotely, the printing device may be queried by a network protocol (e.g., SNMP, IPP, HTTP). If the printing device is connected to a network print queue, the printer driver may query the network print server, which in turn would query the printing device. Otherwise, the printer may query the printing device directly.

Sharp® Corporation's NJR protocol is an example of a proprietary technique that is used to obtain device information. This protocol works by sending a null print job (e.g., no output printed) with proprietary PJL commands that request information be returned to the computing device at a specified network address and port. The computing device creates a process that listens on the specified port for the return information.

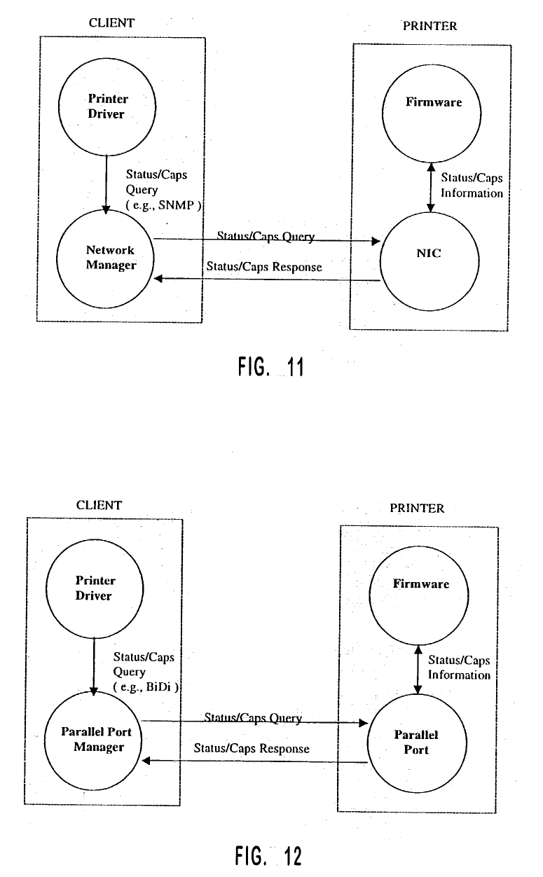

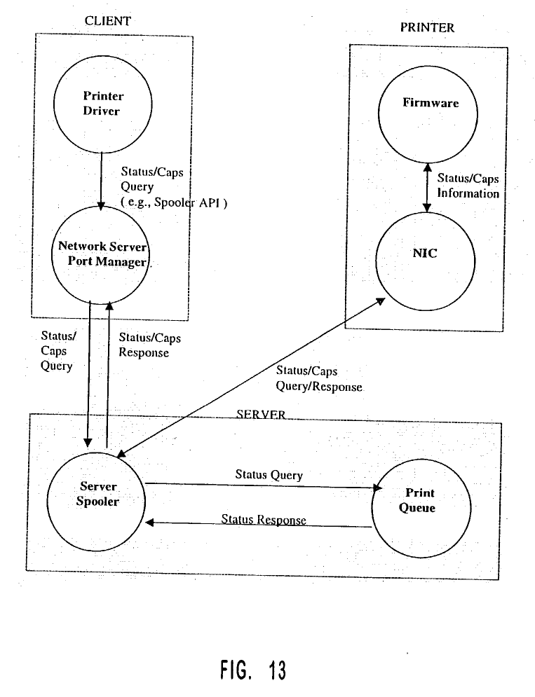

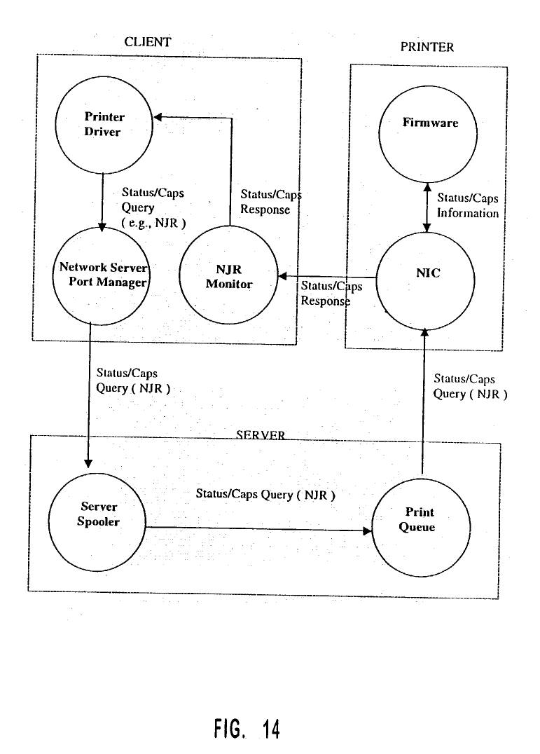

In an alternate embodiment, the printer driver may query the printing device for the non-volatile information only, such as the identification and capabilities, and directly query each device listed in the identification for the volatile information, such as status. FIGS. 11-14 are representative embodiments of querying information.

When a print job is being sent to a lead printing device that is currently printing another print job (i.e., busy), the printer driver checks the status of alternate printing devices. The printer driver may then automatically or interactively redirect the print job to an alternate printing device under various conditions, such as (i) in an idle state and warmed up, (ii) in an idle state and non-warmed up (power save), or (iii) in a busy state with the smallest load.

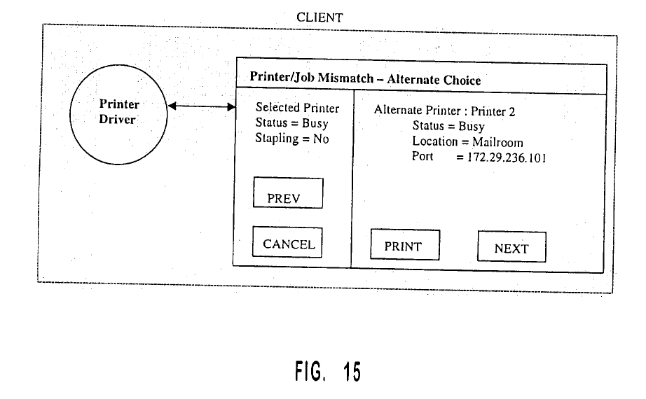

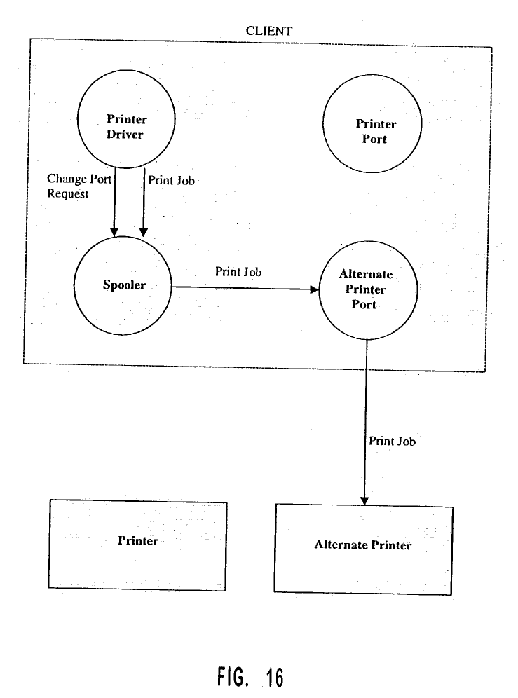

Under automatic redirection, the printer driver may notify the user of why the print job was redirected and to where it was redirected. Under interactive redirection, the printer driver displays why the print job should be redirected and the alternate printing devices that could print the print job under the specified conditions. The user may then select to redirect the print job to one of the alternate printing devices, render the print job at the lead printer device, or cancel the print job. FIG. 15 is a representative example thereof.

When a print job is being sent to a printing device that is in an error state (e.g., paper jam) or offline state (e.g., set to offline on front panel), a printer driver checks the status of the alternate printing devices. The printer driver may then automatically, or interactively, redirect the print job to an alternate printing device under various conditions, such as (i) in a non-error/offline state or (ii) in a warning state (e.g., low toner).

When a print job is being sent to a printing device that does not have one or more capabilities required for the print job (e.g., duplex, stapling), a printer driver checks the capabilities of the alternate printing devices. The printer driver may then automatically or interactively redirect the print job to an alternate printing device under various conditions, such as according to conditions relating to (i) sheet assembly, (ii) finishing, (iii) rendering, (iv) collation, (v) paper, or (vi) trays.

In an alternate embodiment, the printer driver may has the ability to emulate one or more of the mismatched capabilities, such as (i) copy collation, (ii) reverse order, (iii) page range, (iv) booklet, (v) N-up, or (vi) print club. If the printing device is able to meet the requirements by emulation, the printer driver continues to send the print job to the lead printing device. Otherwise, the printer driver considers emulation with the alternate printing devices to find one or more devices capable of meeting the requirements of the print job. FIG. 15 is an example thereof, and wherein the following relates to information obtain:

Query

status=ready

stapling=yes

duplex=yes

media=letter

Response

Lead/Target Printer

status=ready

no stapling

Alternate Printer 1

status=low toner/ready

printer model name

printer name

location

network address

network queue

Alternate Printer 2

status=busy

printer model name

printer name

location

network address

network queue

When a print job has been sent to a printing device that fails to complete the printing of the print job, such as due to a paper jam that occurs during the printing of the job, the printer driver checks (e.g., polls or traps) the status of the print job. If the printer driver detects that the print job failed to completely print, the printer driver checks the status of the alternate printing devices. The printer driver may then automatically or interactively redistribute or restart all or part of the print job to an alternate printing device under various conditions, such as in a non-error/offline state.

When a multiple copy print job is sent to a lead printing device, the printer driver checks the capabilities of the alternate printing devices and may automatically or interactively split the number copies printed on each printing device by sending a copy of the print job to each alternate printing device with the copy count command adjusted accordingly. Examples of such distribution types include (i) equal distribution (e.g., same number of copies) or (ii) load balanced distribution (e.g., ppm speed).

When a multiple page print job is being sent to a printing device, the printer driver checks the capabilities of the alternate printing devices and automatically or interactively splits the sheets printed on each printing device by sending a modified version of the print job that includes only the corresponding sheets to each alternate printing device. Examples of such distribution types include (i) equal distribution (e.g., same number of copies) or (ii) load balanced distribution (e.g., ppm speed).

When a mixed black & white and color print job is sent to a printing device, the printer driver checks the capabilities of the alternate printing devices and then automatically or interactively separates the color and black & white sheets printed on each printing device by sending a modified version of the print job that includes only the corresponding sheets to each alternate printing device. Examples of such distributions include (i) color sheets to a color printing device and (ii) black & white sheets to a black & white printing device.

A printing device may also provide the user with instructions for reassembly of the print job. Examples of providing such instructions include (i) by user notification (e.g., send instructions back as message to client computing device), and (ii) by reassembly instructions printed with the print job.

While examples provided herein disclose possible actions taken for a specific cluster setting, those skilled in the art will appreciate that the settings may also be combined for more complex actions, such as busy and capabilities matching in pool printing. Furthermore, embodiments of the present invention only requires the targeted printer to have a special firmware/front panel display, alternate printers do not require the special firmware/front panel.

In accordance with embodiments of the present invention, the cluster printer driver redirects the print job to one or more alternate printing devices by changing its assigned port. In the Microsoft® family of operating systems, this may be done through a request, to the spooler, such as a SetPrinter ( ) API call. The cluster driver temporarily, for just this job, changes its assigned port to the port of the alternate printing device. When the print job is spooled to the spooler, the spooler despools the print job to the alternate port.

For a job splitting print job, the cluster printer driver creates multiple print streams, one per alternate printing device, and schedules a new print job with the spooler. When these newly created jobs are spooled to the spooler, the spooler will despool the print job to the associated ports.

Thus, as discussed herein, the embodiments of the present invention embrace providing enhanced utilization of printing devices in a cluster-printing environment. More particularly, the present invention relates to systems and methods for redirecting all or part of a print job to one or more alternate printing devices in a local, remote or network printing environment, prior to or after the print job has been despooled to a printing device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a printing environment, a method for selectively allocating at least a portion of a print job from a lead printing device to an alternate printing device, the method comprising steps for:
providing a printer cluster that includes a lead printing device and one or more alternate printing devices;
identifying an availability of the alternate printing devices;
identifying a capability of the alternate printing devices;
receiving print job distribution input at the lead printing device to determine distribution of a print job, wherein the print job distribution input is from one of:
(i) the lead printing device; and
(ii) a client computer device; and
selectively distributing the print job within the printer cluster, wherein the print job is distributed at the lead printing device.

2. A method as recited in claim 1, wherein the printing environment is one of:
(i) a local printing environment;
(ii) a networked printing environment; and
(iii) a remote printing environment.

3. A method as recited in claim 1, wherein the step for selectively distributing the print job includes a step for informing a user of the distribution of the print job.

4. A method as recited in claim 1, further comprising a step for obtaining from firmware of the lead printing device one or more alternate choices of using a printing device of the printer cluster in rendering at least a portion of the print job, wherein the step for obtaining one or more alternate choices comprises a step for using at least one of (i) the availability identified and (ii) the capability identified to obtain the one or more alternate choices.

5. A method as recited in claim 4, further comprising a step for displaying the one or more alternate choices to a user on at least one of (i) a monitor; (ii) a screen at the lead printing device; and (iii) another output device.

6. A method as recited in claim 1, wherein the step for selectively distributing the print job includes steps for:
determining to render at least a portion of the print job at the lead printing device; and
rendering the at least a portion of the print job at the lead printing device.

7. A method as recited in claim 1, wherein the step for selectively distributing the print job includes a step for redirecting at least a portion of the print job to the one or more alternate printing devices prior to despooling the print job to the lead printing device.

8. A method as recited in claim 1, wherein the step for selectively distributing the print job includes a step for redirecting at least a portion of the print job to the one or more alternate printing devices after despooling the print job to the lead printing device

9. A method as recited in claim 1, further comprising steps for:
monitoring a rendering of the print job; and
if at least a portion of print job failed, selectively redistributing the failed portion to another printing device of the printer cluster for rendering.

10. A method as recited in claim 1, wherein the step for selectively distributing the print job includes steps for:
detecting that the print job is a multiple copy print job; and
distributing one of the multiple copies to one of the one or more alternate printing devices of the printer cluster.

11. A method as recited in claim 1, wherein the step for selectively distributing the print job includes steps for:
detecting that the print job is a multiple sheet print job; and
distributing one of the multiple sheets to one of the one or more alternate printing devices of the printer cluster.

12. A method as recited in claim 1, wherein the step for selectively distributing the print job includes steps for:
detecting that the print job includes a color portion; and
distributing the color portion to one of the one or more alternate printing devices of the printer cluster.

13. A method as recited in claim 1, wherein the capability identified is at least one of:
(i) a page per minute capability;
(ii) a sheet assembly capability;
(iii) a collation capability;
(iv) is a finishing capability; and
(v) a media capability

14. A method as recited in claim 13, wherein the step for selectively distributing the print job includes a step for distributing at least a portion of the print job based on the capability identified.

15. A method as recited in claim 1, wherein the capability identified is a non-collating capability, and wherein the step for selectively distributing the print job includes a step for emulating collation using at least one of the one or more alternate printing devices.

16. A method as recited in claim 1, wherein the steps for identifying an availability and identifying a capability are performed without additional client side or server side software.

17. A method as recited in claim 1, wherein the steps for receiving print job distribution and selectively distributing the print job are performed by a printer driver, printer firmware, and a front panel user interface.

18. A method as recited in claim 1, wherein the steps for receiving print job distribution and selectively distributing the print job are performed by printer firmware, a network interface card, and a front panel user interface.

19. A print job distribution system comprising:
a lead printing device configured to receive a print job, wherein the lead printing device is one of a printer cluster;
a computer device configured to initiate the print job; wherein the computer device is connected to the lead printing device;
one or more alternate printing devices of the printer cluster, wherein the one or more alternate printing devices are connected to the lead printing device; and
a print job distribution mechanism configured to selectively distribute the print job within the printer cluster for rendering, wherein the print job distribution mechanism includes the lead printing device and input received at the lead printing device.

20. A print job distribution system as recited in claim 19, wherein the connections of the computer device and the alternate printing devices to the lead printing device include at least one of:
(i) a local connection;
(ii) a remote connection; and
(iii) a network connection.

21. A print job distribution system as recited in claim 19, further comprising a print server coupled to the computer device, and wherein the computer device is a client computer device.

22. A print job distribution system as recited in claim 19, wherein neither the client computer device nor the print server include additional software to perform at least one of:
(i) an identification of the alternate printing devices;
(ii) a configuration of the alternate printing devices;
(iii) a discovery of a status of the alternate printing devices; and
(iv) a discovery of a capability of the alternate printing devices.

23. A print job distribution system as recited in claim 19, wherein the lead printing device includes a front panel user interface configured to receive input.

24. A computer program product for implementing within a computer system a method for selectively allocating at least a portion of a print job from a lead printing device to an alternate printing device, the computer program product comprising:
a computer readable medium of the lead printing device in a printer cluster for providing computer program code means utilized to implement the method, wherein the computer program code means is comprised of executable code for implementing steps for:
receiving a print job for rendering;
identifying an availability of one or more alternate printing devices of the printer cluster;
identifying a capabilities of the one or more alternate printing devices;
receiving print job distribution input at the lead printing device to determine distribution of a print job, wherein the print job distribution input is from one of:
(i) the lead printing device; and
(ii) a client computer device; and
selectively distributing the print job within the printer cluster for rendering.

25. A computer program product as recited in claim 24, wherein the step for selectively distributing the print job includes steps for:
determining to render at least a portion of the print job at the lead printing device; and
rendering the at least a portion of the print job at the lead printing device.

26. A computer program product as recited in claim 24, wherein the step for selectively distributing the print job includes a step for redirecting at least a portion of the print job to the one or more alternate printing devices prior to despooling the print job to the lead printing device.

27. A computer program product as recited in claim 24, wherein the step for selectively distributing the print job includes a step for redirecting at least a portion of the print job to the one or more alternate printing devices after despooling the print job to the lead printing device.

28. A computer program product as recited in claim 24, wherein the computer program code means further includes executable code for implementing steps for:
monitoring a rendering of the print job; and
if at least a portion of print job failed, selectively redistributing the failed portion to another printing device of the printer cluster for rendering.

29. A computer program product as recited in claim 24 wherein the step for selectively distributing the print job includes a step for distributing at least a portion of the print job based on the capability identified.

30. A computer program product as recited in claim 24, wherein the capability identified is a non-collating capability, and wherein the step for selectively distributing the print job includes a step for emulating collation using at least one of the one or more alternate printing devices.
